(19) United States
(12) Patent Application Publication
(10) Pub. No.: US 2022/0277365 A1
(43) Pub. Date: Sep. 1, 2022

(54) U3D 3D OBJECT IDENTIFICATION AND REGISTRATION SYSTEM

(71) Applicant: Andrew Dosa KIM, Sandy Springs, GA (US)

(72) Inventor: Andrew Dosa KIM, Sandy Springs, GA (US)

(21) Appl. No.: 17/469,856

(22) Filed: Sep. 8, 2021

Related U.S. Application Data
(60) Provisional application No. 63/075,611, filed on Sep. 8, 2020.

(51) Int. Cl. G06Q 30/04

(52) U.S. Cl. CPC G06Q 30/04; G06Q 2220/18

(57) ABSTRACT

An exemplary 3UD object identification and registration system enables a owner or creator of a 3D file to upload this owner 3D file to the operating system for registration. If the 3D file is deemed, through analysis to be original, the owner can register the 3D file and may require a licensing fee by other users for future use or may designate the 3D file as fee or open to the public. A user may be required manually or automatically to confirm that a user 3D file is authorized for use. A software on a 3D printer may interface with the operating software upload 3D files prior to allowing the user to print an object from the 3D file. A user may also search the database for a 3D file that they can use and they may be required to pay a licensing fee.

### CROSS-REFERENCE TO RELATED APPLICATIONS

This application claims the benefit of U.S. Provisional Application No. 63/075,611, filed on Sep. 8, 2020, which is incorporated herein by reference.

### BACKGROUND OF THE INVENTION

Field of the Invention

The invention relates to a system to authenticate 3D files of objects and particularly 3D files used for 3D printing of object, based on dimensions of the object, or ratios of features in the object, measurements, and functionality to distinguish determine a unique file and associated place of origin or ownership.

Background

There are challenges with authenticating the origin of 3D files that may be used for 3D printing. Creators of 3D files often have these files used without permission. A file used without permission may be used to print many copies of an object, such as a commercial or industrial product, that may have trademark protection, or be covered under a claim in a design patent and/or utility patent. Counterfeiting printable items has become a big problem for large companies, especially those that make trademarked or patented products, including toys that may be of a trademarked character.

### SUMMARY OF THE INVENTION

The invention is directed to a Universal 3D database (U3D) object identification and registration system configured to identify 3D files and authenticating a 3D file based on dimensions of the object, or ratios of features in the object, measurements of features of the object or of the entire object, and functionality to distinguish determine a unique file and associated place of origin or ownership. The system includes a database that is configured to receive and review files through an operating software that runs on an operating computer. The operating software may have artificial intelligence to analyze and identify 3D designs that are substantially the same as a registered 3D design. The 3D files may be quickly grouped into categories based on the type of design to enable quicker analysis of those in the database. For example, a spoon may be quickly identified by the operating software and compared based on the curvature of the spoon, length to diameter ratios, etc.

An exemplary 3UD object identification and registration system comprises an operating software that interfaces with a database for receiving, registering and storing an uploaded owner 3D file. The system also includes an owner software program that is operable on an owner computer by a 3D owner to upload an owner 3D file to produce an uploaded owner 3D file on the database. An owner may upload an owner 3D file and the system may identify the object and determine authenticity of an original 3D file. If the uploaded owner 3d file is authentic and original, the owner may then register the uploaded owner 3D file. They may register the 3D file by providing their information, financial information and licensing terms for the user of their owner 3D file. An owner may select a licensing term for use of the 3D file by other users or may select “free” wherein the 3D file is then fee to use by the public. If the uploaded owner 3D file is substantially the same as another registered 3D file, the owner may be informed of this matter.

The system further comprises a user software program that is operable on a user computer by a user, that interfaces with the operating software to authorize use of a user 3D file prior to use. The user may have a user 3D file and before they are authorized to use it, the system may identify the owner 3D file and determine if it matches any of the 3D files in the database. The user may be operating a user computing system that has user software that automatically uploads user 3D files prior to authorizing the user to use said user 3D file. The user computing system may be part of a 3D printer and the printer may plug-in software that requires authorization from the 3UD object identification and registration system prior to printing the 3D object. In this way, a user will be prevented from counterfeiting 3D objects. A user may also proactively search the database for a 3D file that they may use. The user interface may enable the user to search by key words to more quickly preview 3D preview files, which may be shown in a format to allow the user to rotate the 3D file or object on a display screen to fully appreciate the 3D file design. The user may put in a key word of “spoon” for example and a plurality of spoon designs in the form of 3D preview files may be provide to the user's computer. A user may also search “free” designs to find 3D files in the database that do not require a licensing fee.

The term “3D”, as used herein, refers to three-dimensional and is used in reference to digital files that describe a 3D object that may be printed or may be used in a 3D simulation or video or interactive computer program such as a game.

The term U3D refers to a Universal 3D database, which is the database as used herein that retains a plurality of 30 digital files.

The summary of the invention is provided as a general introduction to some of the embodiments of the invention, and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 shows a diagram of an exemplary 3UD object identification and registration system that a user is using to search for and find a 3D file that they can use for on their user computer, which may include a 3D printer.

FIG. 2 shows a diagram of an exemplary 3D file object recognition and 3D file registration system, wherein the user's computer, a 3D printer, has a user software program that interfaces with the database to authenticate that the user's 3D file can be used and if required, providing them a authentication key for further using the user 3D file.

Corresponding reference characters indicate corresponding parts throughout the several views of the figures. The figures represent an illustration of some of the embodiments of the present invention and are not to be construed as limiting the scope of the invention in any manner. Some of the figures may not show all of the features and components of the invention for ease of illustration, but it is to understood that where possible, features and components from one figure may be an included in the other figures. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

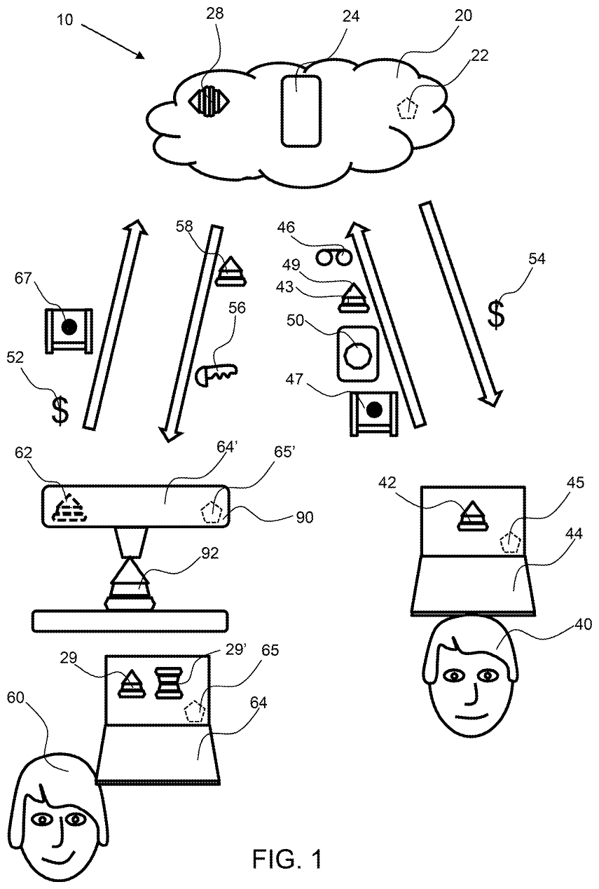

As shown in FIG. 1, an exemplary 3UD object identification and registration system 10 enables a user 60 to search for and find a database 3D file 28 that they can use for on their user computer 65, which may include a 3D printer 90 to 3D print a printed object 92 from the selected and downloaded 3D file 58 that is now the user 3D file 62. The 3D printer may include a user computer 65′ that has a user software program 64′ that interfaces directly with the operating software 22. The user may first search the database, using key words to preview 3D preview files 29, 29′ on the user computer 65 which may operate a user software program 64 to interface with the operating software 22 or operating computer 24 of the database 20. The user may select a preview file from a plurality of 3D preview files and may be required to pay a user licensing fee 52 in order to obtain the downloaded 3D file 58 and the authentication key 56 to use the user 3D file 62. The downloaded file may be encrypted for security. A user may be required to provide user financial data 67, such as credit card details, banking or other payment data to enable the 3UD object identification and registration system 10 to charge the user for use of the downloaded 3D file.

A 3D owner, such a person or company that has created an owner 3D filed 42 may receive an owner licensing payment 54, which may be a portion of the user licensing fee 52, from the 3UD object identification and registration system 10 when a user downloads and uses their uploaded owner 3D file 43. The owner may use an owner computer 45 having an owner software program 44 that interfaces with the operating software 22 or operating computer 24 of the database 20 to provide an uploaded owner 3D file 42 to the database 20, such as by uploading it. The file may be encrypted for security and may comprise a hash-key 49 to enable the owner to track the use of the file. The owner may also provide ownership data 46, which may include trademark registration numbers or details, design patent numbers and details, and/or utility patent numbers and details. The owner may also provide licensing terms 50 or select them or approve of them through the interface with the operating software 22. Finally, an owner may also provide financial data 47, such as credit card details, banking or other payment data to enable payment in the form of an owner licensing payment 54.

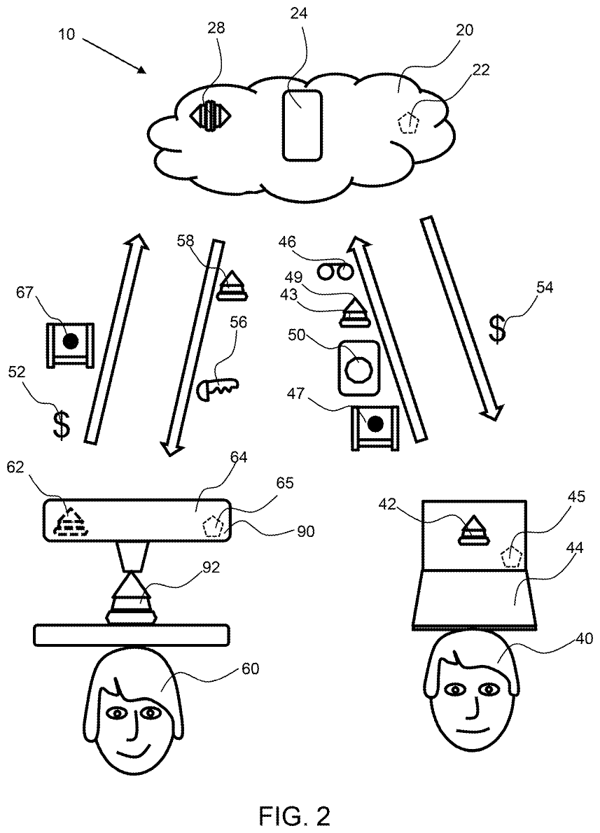

FIG. 2 shows a diagram of an exemplary 3UD object identification and registration system 10, wherein the user computer 65, which is coupled with a 3D printer 90, has a user software program 64 that interfaces with the operating software 22 and database 20 to analyze the user 3D file 62 and determine if the user is free to use the user 3D file. The user may be required to pay a user licensing fee 52 to receive an authenticate key 56 to use the user 3D file 62 which may be a downloaded 30 file 58 from the database 20. As shown in FIG. 1, a user may be required to provide user financial data 67, such as credit card details, banking or other payment data to enable the 3UD object identification and registration system 10 to charge the user for use of the use of the 3D file. Again, an owner 40 may receive an owner licensing payment 54, which may be a portion of the user licensing fee 52, from the 3UD object identification and registration system 10 when a user downloads and/or uses the uploaded owner 3D file 43.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents.

What is claimed is:

1. A 3UD object identification and registration system comprising:
a) an operating software that interfaces with a database for receiving, registering and storing an uploaded owner 3D file;
b) an owner software program that is operable on an owner computer by a 3D owner to upload an owner 3D file to produce an uploaded owner 3D file on the database;
c) a user software program that is operable on a user computer by a user, that interfaces with the operating software to authorize use of a user 3D file prior to use.

2. The 3UD object identification and registration system of claim 1, wherein the user 30 file is a downloaded 3D file from the database.

3. The 3UD object identification and registration system of claim 2, wherein the user 3D file is a 3D file selected by the user from a 3D preview file.

4. The 3UD object identification and registration system of claim 3, wherein a user licensing fee is required by the user to the 3UD object identification and registration system prior to use of said user 3D.

5. The 3UD object identification and registration system of claim 4, wherein the user 3D file is an uploaded owner 3D file.

6. The 3UD object identification and registration system of claim 1, wherein the user 3D file is an uploaded user 3D file provided by the user to the database.

7. The 3UD object identification and registration system of claim 6, wherein the user is not authorized to use said uploaded user 3D file without payment of a user licensing fee to the 3D file object recognition and 3D file registration system.

8. The 3UD object identification and registration system of claim 1, wherein the user software program is a plug-in software.

9. The 3UD object identification and registration system of claim 1, wherein the user software program is coupled with a 3D printer.

10. The 3UD object identification and registration system of claim 9, wherein the 3D printer is configured to print the user 3D file to produce a 3D printed object.

11. A method of identifying and registering a 3D file comprising:
a) providing the 3UD object identification and registration system of claim 1;
b) uploading a plurality of owner 3D filed to the database;
c) authorizing a user 3D file prior to use by a user.

12. The method of claim 11, wherein the user downloads said user 3D file from the database.

13. The method of claim 12, wherein the user 3D file is a 3D file selected by the user from a 3D preview file.

14. The method of claim 13, wherein a user licensing fee is required by the user to the 3UD object identification and registration system prior to use of said user 3D.

15. The method of claim 14, wherein the user 3D file is an uploaded owner 3D file.

16. The method of claim 11, wherein the user 3D file is an uploaded user 3D file provided by the user to the database.

17. The method of claim 16, wherein the user is not authorized to use said uploaded user 3D file without payment of a user licensing fee to the 3D file object recognition and 3D file registration system.

18. The method of claim 11, wherein the user software program is a plug-in software.

19. The method of claim 11, wherein the user software program is coupled with a 3D printer.

20. The method of claim 19, wherein the 3D printer is configured to print the user 3D file to produce a 3D printed object.
